(19) United States
(12) Patent Application Publication
(10) Pub. No.: US 2018/0188817 A1
(43) Pub. Date: Jul. 5, 2018

(54) ELECTRONIC DEVICE, COMPUTER-READABLE NON-TRANSITORY RECORDING MEDIUM, AND CONTROL METHOD

(71) Applicant: KYOCERA Corporation, Kyoto (JP)

(72) Inventors: Taro IIO, Yokohama-shi (JP); Yuuya YAMAGUCHI, Yokohama-shi (JP); Ryohei NAKAMURA, Yokohama-shi (JP); Tsuneo MIYASHITA, Yokohama-shi (JP)

(73) Assignee: KYOCERA Corporation, Kyoto (JP)

(21) Appl. No.: 15/855,509

(22) Filed: Dec. 27, 2017

(30) Foreign Application Priority Data
Jan. 4, 2017 (JP) 2017-000237
Jan. 4, 2017 (JP) 2017-000238

(51) Int. Cl. G06F 3/01; G06F 3/0346

(52) U.S. Cl. CPC G06F 3/017; G06F 3/0346

(57) ABSTRACT

An electronic device comprises: a proximity sensor; and a controller configured to determine a direction of a gesture in accordance with an output from the proximity sensor and a state of the electronic device.

### CROSS REFERENCE TO RELATED APPLICATION

This application claims priority from and the benefit of Japanese Patent Application No. 2017-000237 filed on Jan. 4, 2017 and Japanese Patent Application No. 2017-000238 filed on Jan. 4, 2017, the entire contents of which are incorporated herein by reference.

### TECHNICAL FIELD

This disclosure relates to an electronic device, a computer-readable non-transitory recording medium, and a control method.

### BACKGROUND

An electronic device such as a smartphone or a tablet typically includes a touch panel. A user usually controls the electronic device by touching the touch panel. An electronic device that detects, using a proximity sensor such as an infrared sensor, a gesture made by a user distant from the terminal and performs an input operation corresponding to the gesture is known.

### SUMMARY

An electronic device according to an aspect of this disclosure comprises: a proximity sensor; and a controller configured to determine a direction of a gesture in accordance with an output from the proximity sensor and a state of the electronic device.

A computer-readable non-transitory recording medium according to an aspect of this disclosure is a computer-readable non-transitory recording medium storing therein instructions to be executed by an electronic device including a proximity sensor and a controller, the instructions causing the controller to determine a direction of a gesture in accordance with an output from the proximity sensor and a state of the electronic device.

A control method according to an aspect of this disclosure is a control method for an electronic device including a proximity sensor and a controller, the control method comprising determining, by the controller, a direction of a gesture in accordance with an output from the proximity sensor and a state of the electronic device.

An electronic device according to an aspect of this disclosure comprises: a proximity sensor; and a controller configured to perform a process on the basis of a gesture in accordance with an output from the proximity sensor, wherein the controller is configured to determine, when a second gesture is detected after a first gesture in accordance with the output from the proximity sensor, whether the second gesture is valid or invalid, on the basis of the first gesture and the second gesture.

A computer-readable non-transitory recording medium according to an aspect of this disclosure is a computer-readable non-transitory recording medium storing therein instructions to be executed by an electronic device including a proximity sensor and a controller, the instructions causing the controller to: perform a process on the basis of a gesture in accordance with an output from the proximity sensor; and determine, when a second gesture is detected after a first gesture in accordance with the output from the proximity sensor, whether the second gesture is valid or invalid, on the basis of the first gesture and the second gesture.

A control method according to an aspect of this disclosure is a control method for an electronic device including a proximity sensor and a controller, the control method comprising: performing, by the controller, a process on the basis of a gesture in accordance with an output from the proximity sensor; and determining, by the controller, when a second gesture is detected after a first gesture in accordance with the output from the proximity sensor, whether the second gesture is valid or invalid, on the basis of the first gesture and the second gesture.

### BRIEF DESCRIPTION OF THE DRAWINGS

In the accompanying drawings:

FIG. 1 is a schematic diagram illustrating an electronic device according to an embodiment;

FIG. 2 is a diagram illustrating how a user operates the electronic device using a gesture;

FIG. 3 is a schematic diagram illustrating a proximity sensor;

FIG. 4 is a diagram illustrating changes in detection values detected by infrared photodiodes;

FIG. 5 is a diagram illustrating a situation wherein the electronic device is operated using a gesture;

FIG. 6 is a conceptual diagram illustrating gesture direction determination;

FIG. 7 is a diagram schematically illustrating an example of a gesture made by the user;

FIG. 8A is a diagram illustrating an example of a screen displayed on a display in the electronic device;

FIG. 8B is a diagram illustrating an example of the screen displayed on the display in the electronic device;

FIG. 9 is a conceptual diagram illustrating allocation for gesture direction determination;

FIG. 10A is a diagram illustrating the relationship between the orientation of the electronic device and the allocation for gesture direction determination;

FIG. 10B is a diagram illustrating the relationship between the orientation of the electronic device and the allocation for gesture direction determination;

FIG. 11 is a flowchart illustrating an example of a process performed by the electronic device;

FIG. 12 is a diagram illustrating an example of a continuous gesture made by the user;

FIG. 13 is a flowchart illustrating an example of a process performed by the electronic device; and

FIG. 14 is a diagram schematically illustrating an example of a gesture made by the user.

### DETAILED DESCRIPTION

(Electronic Device Structure)

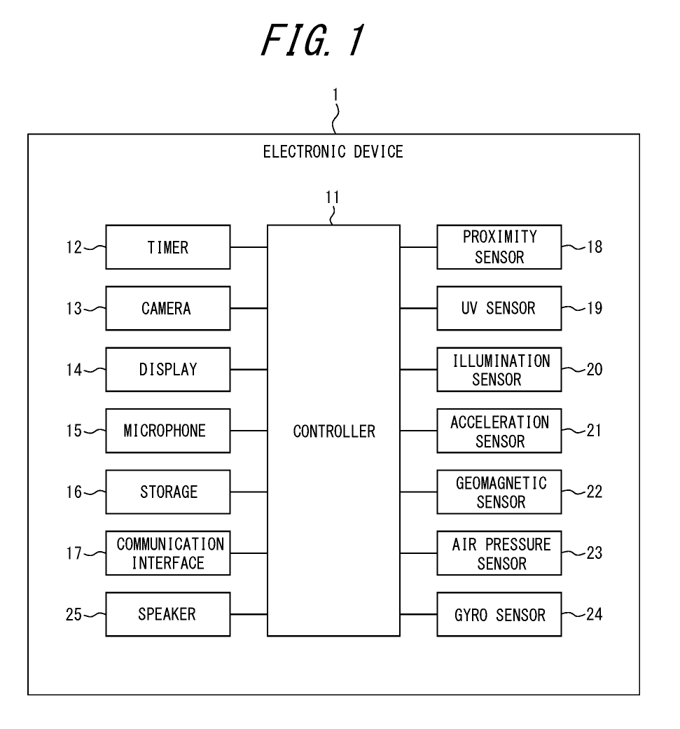

As illustrated in FIG. 1, an electronic device 1 according to an embodiment includes a timer 12, a camera 13, a display 14, a microphone 15, a storage 16, a communication interface 17, a speaker 25, a proximity sensor 18 (gesture sensor), and a controller 11. The electronic device 1 also includes a UV sensor 19, an illumination sensor 20, an acceleration sensor 21, a geomagnetic sensor 22, an air pressure sensor 23, and a gyro sensor 24. FIG. 1 illustrates an example. The electronic device 1 does not necessarily need to include all structural elements illustrated in FIG. 1. The electronic device 1 may include one or more structural elements other than those illustrated in FIG. 1.

The timer 12 receives a timer operation instruction from the controller 11 and, when a predetermined time has elapsed, outputs a signal indicating the elapse of the predetermined time to the controller 11. The timer 12 may be provided independently of the controller 11 as illustrated in FIG. 1, or included in the controller 11.

The camera 13 captures a subject in the vicinity of the electronic device 1. As an example, the camera 13 is a front-facing camera provided on the surface on which the display 14 of the electronic device 1 is provided.

The display 14 displays a screen. The screen includes at least any of characters, images, symbols, graphics, and the like. The display 14 may be a liquid crystal display, an organic electro-luminescence (EL) panel, an inorganic electro-luminescence (EL) panel, or the like. In this embodiment, the display 14 is a touch panel display (touchscreen display). The touch panel display detects a touch of a finger, a stylus pen, or the like, and determines the position of the touch. The display 14 can simultaneously detect a plurality of positions where a finger, a stylus pen, or the like touches the touch panel.

The microphone 15 detects sound around the electronic device 1, including human voice.

The storage 16 serves as a memory for storing programs and data. The storage 16 temporarily stores processing results of the controller 11. The storage 16 may include any storage device such as a semiconductor storage device or a magnetic storage device. The storage 16 may include a plurality of types of storage devices. The storage 16 may include a combination of a portable storage medium such as a memory card and a reader of the storage medium.

Programs stored in the storage 16 include applications executed in the foreground or the background, and a control program for assisting the operations of the applications. The applications, for example, cause the controller 11 to perform a process corresponding to a gesture. The control program is, for example, an operating system (OS). The applications and the control program may be installed in the storage 16 through communication by the communication interface 17 or via a storage medium.

The communication interface 17 is an interface for performing wired or wireless communication. The communication interface 17 in this embodiment supports a wireless communication standard. The wireless communication standard is, for example, a communication standard relating to cellular phones such as 2G, 3G, and 4G. Examples of the communication standard of cellular phones include Long Term Evolution (LTE), Wideband Code Division Multiple Access (W-CDMA), CDMA 2000, Personal Digital Cellular (PDC), Global System for Mobile Communications (GSM® (GSM is a registered trademark in Japan, other countries, or both)), and Personal Handy-phone System (PHS). Examples of the wireless communication standards further include Worldwide Interoperability for Microwave Access (WiMAX), IEEE 802.11, Bluetooth® (Bluetooth is a registered trademark in Japan, other countries, or both), Infrared Data Association (IrDA), and Near Field Communication (NFC). The communication interface 17 may support one or more of the communication standards mentioned above.

The speaker 25 outputs sound. For example, the speaker 25 outputs the voice of the other party during a call. Moreover, for example, the speaker 25 outputs, by sound, the contents of news or weather forecasts when reading the news or weather forecasts.

The proximity sensor 18 contactlessly detects, for example, the relative distance to an object in the vicinity of the electronic device 1 and the moving direction of the object. In this embodiment, the proximity sensor 18 includes one infrared light emitting diode (LED) as a light source, and four infrared photodiodes. The proximity sensor 18 emits infrared light towards the object from the infrared LED as the light source. The proximity sensor 18 receives light reflected from the object as incident light on the infrared photodiodes. The proximity sensor 18 can then measure the relative distance to the object on the basis of an output current from the infrared photodiodes. The proximity sensor 18 detects the moving direction of the object on the basis of a difference between the times at which the reflected light from the object is incident on each of the infrared photodiodes. The proximity sensor 18 can thus detect an operation using an air gesture (hereafter simply referred to as “gesture”) made by the user of the electronic device 1 without touching the electronic device 1. The proximity sensor 18 may include visible light photodiodes.

The controller 11 is a processor such as a central processing unit (CPU). The controller 11 may be an integrated circuit such as system-on-a-chip (SoC) in which other structural elements have been integrated. The controller 11 may be a combination of a plurality of integrated circuits. The controller 11 integrally controls the operation of the electronic device 1 to realize various functions.

In detail, the controller 11 refers to the data stored in the storage 16 as necessary. The controller 11 executes instructions included in the programs stored in the storage 16 to control the other functional parts such as the display 14, to realize various functions. For example, the controller 11 acquires data relating to touches made by the user from the touch panel. For example, the controller 11 acquires information about a gesture made by the user detected by the proximity sensor 18. For example, the controller 11 acquires information such as a remaining countdown time (i.e. timer time) from the timer 12. For example, the controller 11 recognizes the startup status of each application.

The UV sensor 19 is capable of measuring the amount of ultraviolet light included in sunlight and the like.

The illumination sensor 20 detects illuminance of ambient light incident on the illumination sensor 20.

The acceleration sensor 21 detects the direction and magnitude of an acceleration acting on the electronic device 1. For example, the acceleration sensor 21 is a triaxial (3-dimentional) type sensor for detecting acceleration in the x-axis direction, the y-axis direction, and the z-axis direction. The acceleration sensor 21 may be, for example, piezoresistive type or capacitive type.

The geomagnetic sensor 22 detects the direction of geomagnetism, to measure the orientation of the electronic device 1.

The air pressure sensor 23 detects the air pressure (atmospheric pressure) outside the electronic device 1.

The gyro sensor 24 detects the angular velocity of the electronic device 1. The controller 11 time-integrates the angular velocity acquired by the gyro sensor 24 to measure a change of the orientation of the electronic device 1.

(Electronic Device Gesture-Based Operation)

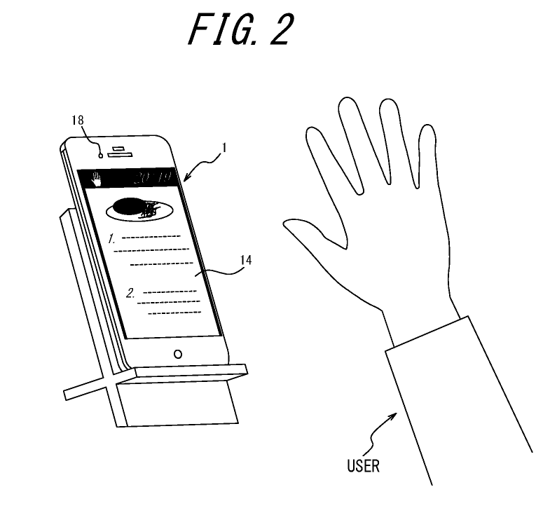

FIG. 2 illustrates how the user operates the electronic device 1 using a gesture. In FIG. 2, the electronic device 1 is supported by a stand as an example. Alternatively, the electronic device 1 may be propped against a wall, or placed on a table. When the proximity sensor 18 detects a gesture made by the user, the controller 11 performs a process based on the detected gesture. In the example in FIG. 2, the process based on the gesture is scrolling of a screen displaying a recipe. For example, when the user makes a gesture by moving his or her hand upward in the longitudinal direction of the electronic device 1, the screen is scrolled up, along with the movement of the user's hand. When the user makes a gesture by moving his or her hand downward in the longitudinal direction of the electronic device 1, the screen is scrolled down, along with the movement of the user's hand.

The electronic device 1 illustrated in FIG. 2 is a smartphone. Alternatively, the electronic device 1 may be, for example, a mobile phone terminal, a phablet, a tablet PC, or a feature phone. The electronic device 1 is not limited to the above, and may be, for example, a PDA, a remote control terminal, a portable music player, a game device, an electronic book reader, a car navigation device, a household appliance, or industrial equipment (e.g. factory automation equipment).

(Gesture Detection Method)

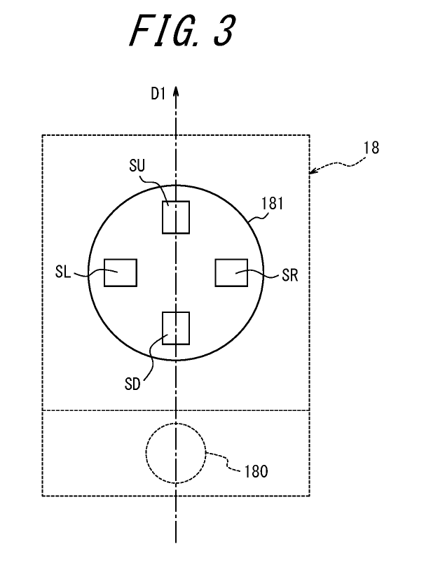

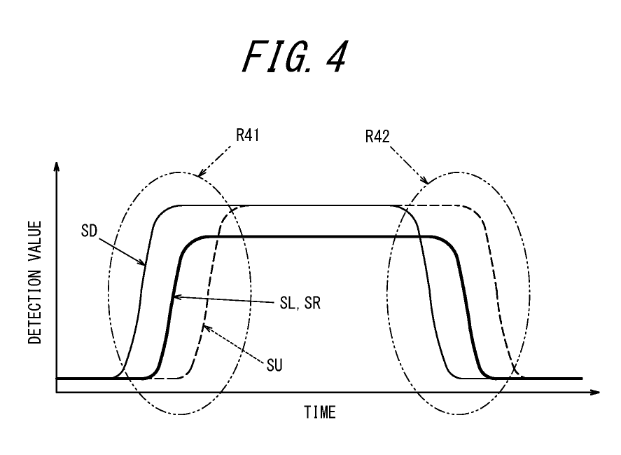

A method by which the controller 11 detects a gesture made by the user based on the output of the proximity sensor 18 is described below, with reference to FIGS. 3 and 4. FIG. 3 is a diagram illustrating an example of the structure of the proximity sensor 18 when the electronic device 1 is viewed from the front. The proximity sensor 18 includes an infrared LED 180 as a light source, and four infrared photodiodes SU, SR, SD, and SL. The four infrared photodiodes SU, SR, SD, and SL detect light reflected from a detection object through a lens 181. The four infrared photodiodes SU, SR, SD, and SL are arranged symmetrically with respect to the center of the lens 181. Here, an imaginary line D1 in FIG. 3 is approximately parallel to the longitudinal direction of the electronic device 1. The infrared photodiodes SU and SD are located away from each other on the imaginary line D1 in FIG. 3. The infrared photodiodes SR and SL are located between the infrared photodiodes SU and SD, in the direction of the imaginary line D1 in FIG. 3.

FIG. 4 illustrates changes in detection values when the detection object (e.g. the user's hand) of the four infrared photodiodes SU, SR, SD, and SL moves along the direction of the imaginary line D1 in FIG. 3. In the direction of the imaginary line D1, the infrared photodiodes SU and SD are farthest from each other. Accordingly, the time difference between a change (e.g. increase) in the detection value of the infrared photodiode SU (dashed line) and the same change (e.g. increase) in the detection value of the infrared photodiode SD (thin solid line) is largest, as illustrated in FIG. 4. The controller 11 can determine the moving direction of the detection object, by recognizing the time difference of a predetermined change between the detection values of the photodiodes SU, SR, SD, and SL.

The controller 11 acquires the detection values of the photodiodes SU, SR, SD, and SL from the proximity sensor 18. For example, to recognize the movement of the detection object in the direction of the imaginary line D1, the controller 11 may integrate the value obtained by subtracting the detection value of the photodiode SU from the detection value of the photodiode SD, by a predetermined time. In the example in FIG. 4, the integral is nonzero in regions R41 and R42. From a change of this integral (e.g. a change of positive value, zero, or negative value), the controller 11 can recognize the movement of the detection object in the direction of the imaginary line D1.

The controller 11 may integrate the value obtained by subtracting the detection value of the photodiode SR from the detection value of the photodiode SL, by a predetermined time. From a change of this integral (e.g. a change of positive value, zero, or negative value), the controller 11 can recognize the movement of the detection object in a direction orthogonal to the imaginary line D1 (i.e. a direction approximately parallel to the transverse direction of the electronic device 1).

As another example, the controller 11 may perform calculation using all of the detection values of the photodiodes SU, SR, SD, and SL. In other words, the controller 11 may recognize the movement of the detection object without separating the moving direction of the detection object between components in the longitudinal direction and transverse direction of the electronic device 1.

A detected gesture is, for example, a right-left gesture, an up-down gesture, a diagonal gesture, a gesture made by drawing a circle clockwise, or a gesture made by drawing a circle counterclockwise. For example, a right-left gesture is a gesture made in a direction approximately parallel to the transverse direction of the electronic device 1. An up-down gesture is a gesture made in a direction approximately parallel to the longitudinal direction of the electronic device 1. A diagonal gesture is a gesture made in a direction not parallel to any of the longitudinal direction and transverse direction of the electronic device 1, in a plane approximately parallel to the electronic device 1.

(Kitchen Mode)

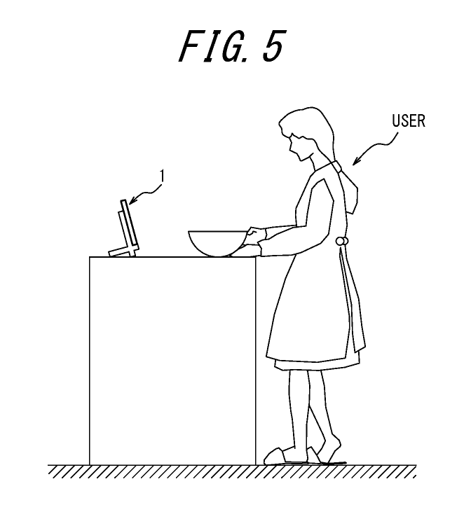

FIG. 5 illustrates an example of a situation where the user operates the electronic device 1 by a gesture. In the example in FIG. 5, while displaying a cooking recipe on the display 14 of the electronic device 1, the user is cooking from the recipe in a kitchen. Here, the proximity sensor 18 detects a gesture made by the user. The controller 11 then performs a process based on the gesture detected by the proximity sensor 18. For example, the controller 11 is capable of a process of scrolling the recipe in response to a specific gesture (e.g. a gesture made by the user moving his or her hand up or down). During cooking, the user's hand may get dirty or wet. However, since the user can scroll the recipe without touching the electronic device 1, the display 14 can be prevented from getting dirty, and the user's hand can avoid transfer of dirt from the display 14 during cooking.

The electronic device 1 has a plurality of modes. The term “mode” denotes an operation mode (i.e. operation state or operation status) that imposes limitations and the like on the overall operation of the electronic device 1. Only one mode can be selected at a time. In this embodiment, the electronic device 1 has a first mode and a second mode. The first mode is, for example, a normal operation mode (i.e. normal mode) suitable for use in rooms other than the kitchen, outside the home, etc. The second mode is an operation mode (i.e. kitchen mode) of the electronic device 1 optimal for cooking while displaying a recipe in the kitchen. In the second mode, it is preferable to enable an input operation by a gesture, as mentioned above. In detail, in the case where the mode of the electronic device 1 switches to the second mode, it is preferable to simultaneously operate the proximity sensor 18 to enable gesture detection. The electronic device 1 in this embodiment includes the below-mentioned user interface, and thus can synchronize the switching to the second mode (i.e. kitchen mode) and the operation of the proximity sensor 18.

(Gesture Direction Determination Method)

A gesture direction determination process by the controller 11 of the electronic device 1 is described below. For example, the gesture direction determination process by the controller 11 may be performed in the case where the electronic device 1 is in the kitchen mode.

In the electronic device 1, the directions in which gestures are detected may be set beforehand. For example, the longitudinal direction of the electronic device 1 and the transverse direction of the electronic device 1 may be set as the directions in which gestures are detected. When a gesture is detected, the controller 11 of the electronic device 1 determines whether the detected gesture is an operation in the longitudinal direction or in the transverse direction. For example, when a gesture is detected, the controller 11 separates the gesture between a component (i.e. movement) in the longitudinal direction and a component (i.e. movement) in the transverse direction. In the case where the component in the longitudinal direction is greater than the component in the transverse direction, the controller 11 determines that the gesture is an operation in the longitudinal direction. In the case where the component in the transverse direction is greater than the component in the longitudinal direction, the controller 11 determines that the gesture is an operation in the transverse direction.

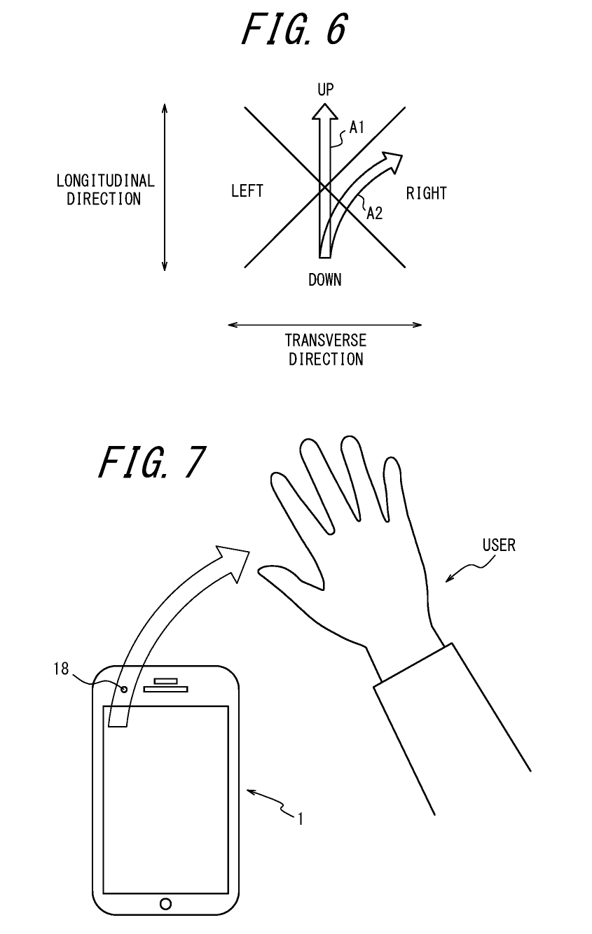

FIG. 6 is a conceptual diagram illustrating gesture direction determination. In FIG. 6, the up-down direction is the longitudinal direction of the electronic device 1, and the right-left direction is the transverse direction of the electronic device 1. In FIG. 6, the longitudinal direction corresponds to the up-down direction of the gesture made by the user, and the transverse direction corresponds to the right-left direction of the gesture made by the user. The direction of the gesture by the user is determined based on criteria allocated evenly in the directions such as up, down, right, and left, as conceptually indicated as regions separated by solid lines in FIG. 6. With such criteria, for example in the case where the user makes a gesture by moving his or her hand upward, the gesture is detected as an upward gesture in the longitudinal direction as indicated by an arrow A1 in FIG. 6, and an upward process is performed in the electronic device 1.

However, there is a possibility that a gesture made by the user is not recognized as a gesture in the direction intended by the user. For example, suppose the user makes a gesture by moving his or her hand in the longitudinal direction (up-down direction), with the intention of performing an operation in the longitudinal direction. For example, in the case where the user makes this gesture with the right hand, the palm of the right hand moves along an arc about the right elbow due to human biomechanics. FIG. 7 schematically illustrates such hand movement by an arrow. In this case, the gesture made by the user has a component in the longitudinal direction intended by the user, and a component in the transverse direction resulting from the palm moving along an arc.

If the controller 11 determines that the component in the transverse direction is greater than the component in the longitudinal direction for this gesture, this may result in the gesture being recognized as an operation in the transverse direction. For example, there is a possibility that the gesture made by the user is detected as a gesture in the transverse direction (i.e. rightward), as conceptually indicated by an arrow A2 in FIG. 6. Since the user intends the gesture to be an operation in the longitudinal direction, an operation error occurs if the controller 11 performs a process in the transverse direction on the basis of the gesture.

The controller 11 of the electronic device 1 according to this embodiment can determine the direction of the gesture based on the output from the proximity sensor 18 and the state of the electronic device 1. By the controller 11 determining the direction of the gesture based on the state of the electronic device 1, a process not intended by the user is suppressed. The electronic device 1 can thus effectively prevent an operation error in gesture input operation.

The gesture direction determination process by the controller 11 based on the state of the electronic device 1 is described in detail below. In the gesture direction determination process, the controller 11 determines a priority direction of the gesture made by the user, in accordance with the output from the proximity sensor 18 and the state of the electronic device 1. The priority direction is a direction preferentially determined as the direction of the gesture made by the user. For example, the priority direction may be a direction in which the user is likely to perform an operation. The controller 11 performs a process that facilitates the detection of the priority direction rather than a direction other than the priority direction, as the control direction indicated by the gesture made by the user. The controller 11 may perform the process by, for example, assigning different weights to the movement in the priority direction and the movement in the other direction. The degree to which the detection in the priority direction is prioritized (i.e. to what extent the priority direction is given priority) may be set appropriately in accordance with the state of the electronic device 1. The degree of priority can be set by the degree of weighting as an example.

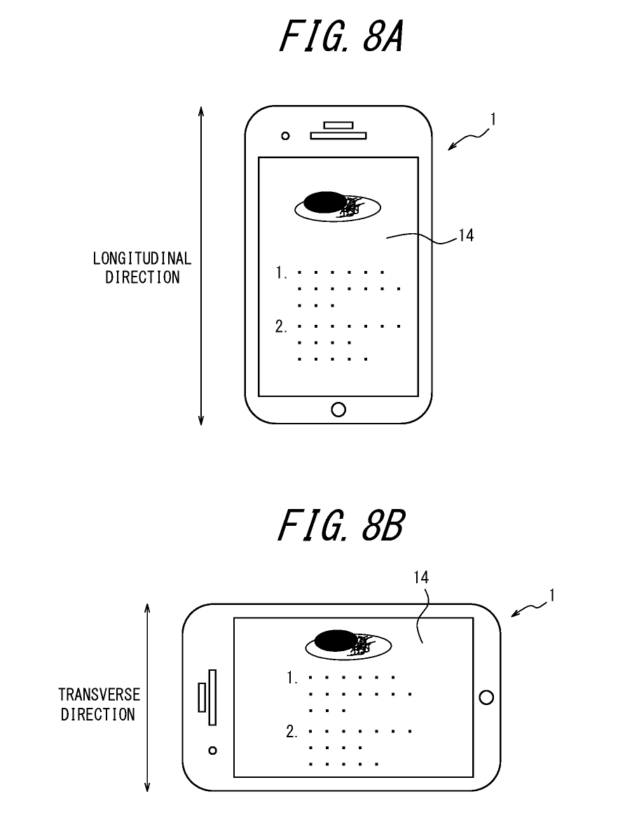

The state of the electronic device 1 may be, for example, the orientation of the screen displayed on the display 14. For example, suppose the display 14 of the electronic device 1 displays the screen in dependence on the orientation of the electronic device 1. For example, the display 14 displays any of the screen in either an orientation in which the user recognizes the longitudinal direction of the electronic device 1 as the vertical direction (up-down direction) as illustrated in FIG. 8A, or an orientation in which the user recognizes the transverse direction of the electronic device 1 as the vertical direction as illustrated in FIG. 8B. The screen displayed on the display 14 may be determined by the controller 11, in accordance with the orientation of the electronic device 1 with respect to the plumb (i.e. vertical) direction determined on the basis of the acceleration sensor 21 and the like. The state of the electronic device 1 may include information of whether the screen displayed on the display 14 is a screen in which the longitudinal direction of the electronic device 1 is recognized as the vertical direction by the user or a screen in which the transverse direction of the electronic device 1 is recognized as the vertical direction by the user.

The controller 11 may determine, for example, the up-down direction as the priority direction, based on the orientation of the screen displayed on the display 14. In this case, the gesture is more likely to be determined as a gesture in the up-down direction than in the right-left direction.

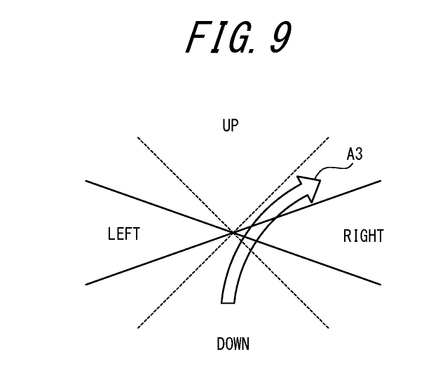

The process performed by the controller 11 is described in detail below, with reference to FIG. 9. FIG. 9 is a conceptual diagram illustrating allocation for gesture direction determination based on the determination of the priority direction. Dashed lines in FIG. 9 correspond to the solid lines separating the up, down, right, and left determination regions in FIG. 6. As illustrated in FIG. 9, the controller 11 reduces the slopes of the solid lines separating the up-down determination regions and the right-left determination regions as compared with those illustrated in FIG. 6, thus widening the regions in which the gesture is determined as upward or downward and narrowing the regions in which the gesture is determined as rightward or leftward. Hence, for example even in the case where the gesture made by the user contains a rightward component as indicated by an arrow A3, the controller 11 can recognize the gesture as an upward gesture.

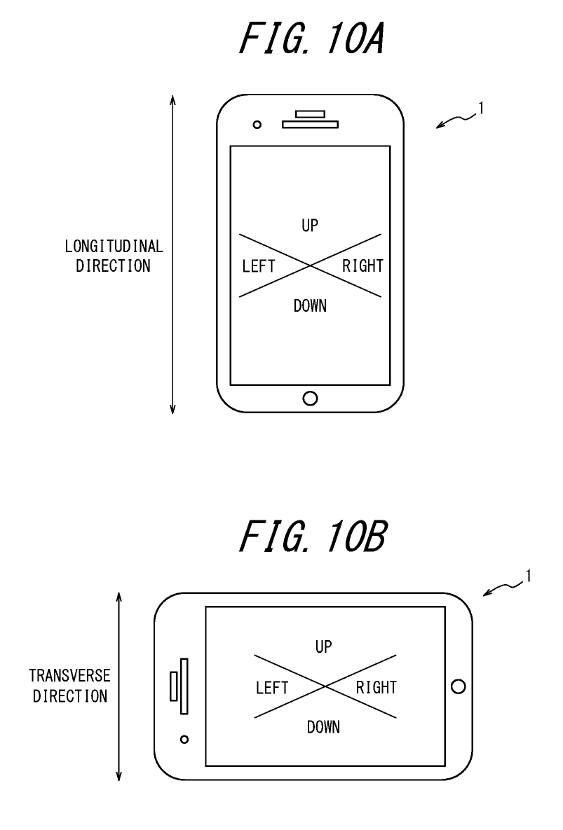

FIGS. 10A and 10B are diagrams illustrating the relationship between the orientation of the electronic device 1 and the allocation for gesture direction determination. FIGS. 10A and 10B are each a conceptual diagram in which the determination regions illustrated in FIG. 9 are overlaid on a view of the electronic device 1.

In the case where the screen displayed on the display 14 is a screen in which the longitudinal direction is recognized as the vertical direction by the user as illustrated in FIG. 10A, the controller 11 associates the longitudinal direction with the up-down direction, and determines the priority direction. In detail, the controller 11 determines the longitudinal direction associated with the up-down direction, as the priority direction. In this case, the controller 11 widens the up-down determination regions as conceptually illustrated in FIG. 10A, and determines the direction of the gesture. Since the up-down determination regions are widened in a state where the longitudinal direction of the electronic device 1 is associated with the up-down direction, the gesture made by the user is more likely to be determined as a gesture along the longitudinal direction of the electronic device 1.

In the case where the screen displayed on the display 14 is a screen in which the transverse direction is recognized as the vertical direction by the user as illustrated in FIG. 10B, on the other hand, the controller 11 associates the transverse direction with the up-down direction, and determines the priority direction. In detail, the controller 11 determines the transverse direction associated with the up-down direction, as the priority direction. In this case, the controller 11 widens the up-down determination regions, and determines the direction of the gesture. Since the up-down determination regions are widened in a state where the transverse direction of the electronic device 1 is associated with the up-down direction, the gesture made by the user is more likely to be determined as a gesture along the transverse direction of the electronic device 1.

Thus, the electronic device 1 determines the up-down direction as the priority direction in accordance with the orientation of the electronic device 1. In this way, for example in the case where a main operation on the screen displayed on the display 14 is an operation in the up-down direction, even when the gesture made by the user contains a component in the right-left direction, the gesture is likely to be recognized as a gesture in the up-down direction which is expected to be more frequent.

The electronic device 1 may determine the right-left direction as the priority direction. In this way, for example in the case where a main operation on the screen displayed on the display 14 is an operation in the right-left direction, even when the gesture made by the user contains a component in the up-down direction, the gesture is likely to be recognized as a gesture in the right-left direction which is expected to be more frequent.

In the electronic device 1, the controller 11 determines the priority direction based on the orientation of the screen displayed on the display 14 in this way, so that the gesture made by the user is more likely to be detected as a gesture in the direction intended by the user. The electronic device 1 can thus effectively prevent an operation error in gesture input operation.

The state of the electronic device 1 is not limited to the orientation of the screen displayed on the display 14. The state of the electronic device 1 may be determined in accordance with, for example, a function executed by the electronic device 1.

As an example, suppose the function that is being executed when the proximity sensor 18 detects the gesture is the browsing of information displayed on the display 14, and the scroll operation of the screen displayed on the display 14 is performed by the gesture in the up-down direction. In this case, the controller 11 may determine the up-down direction of the screen displayed on the display 14, as the priority direction. In the case where the user is browsing information on the display 14, the scroll operation of the screen in the up-down direction is expected to be a main operation. Accordingly, the controller 11 determines the up-down direction corresponding to the scroll operation as the priority direction, so that the gesture made by the user is more likely to be recognized as a gesture in the up-down direction. Thus, the gesture made by the user is more likely to be recognized as a gesture in the up-down direction which is expected to be more frequent.

As another example, suppose the function that is being executed when the proximity sensor 18 detects the gesture is incoming phone call, and a gesture in the right-left direction of moving the hand from left to right enables answering an incoming call in the electronic device 1. In this case, the controller 11 may determine the right-left direction of the screen displayed on the display 14, as the priority direction. In the case where the user answers an incoming call, a gesture in the right-left direction corresponding to the slide operation on the touch panel is expected to be a main operation. Accordingly, the controller 11 determines the right-left direction for answering an incoming call as the priority direction, so that the gesture made by the user is more likely to be recognized as a gesture in the right-left direction. Thus, the gesture made by the user is more likely to be recognized as a gesture in the right-left direction which is expected to be more frequent.

As another example, suppose the function that is being executed when the proximity sensor 18 detects the gesture is the use of a predetermined application. Also suppose, in the application, a gesture in the up-down direction with respect to the orientation of the screen displayed on the display 14 is associated with the scroll operation of the screen, and a gesture in the right-left direction is associated with the operation of switching the display of a predetermined icon on and off. In the case where, for example, the storage 16 pre-stores information indicating that the scroll operation in the up-down direction is a main operation and the icon display switching operation is an auxiliary operation in the application, the controller 11 may determine the up-down direction of the screen displayed on the display 14, as the priority direction. Hence, the gesture made by the user is more likely to be recognized as the scroll operation in the up-down direction which is a main operation, while a gesture in the right-left direction is recognized as the switching operation which is an auxiliary operation.

For example, the priority direction may be stored in the storage 16 in association with each function executed in the electronic device 1. The controller 11 may then determine the direction of the gesture made by the user, based on the priority direction associated with the corresponding function.

Depending on the function executed in the electronic device 1, the controller 11 may detect the gesture made by the user as valid only in one direction, and invalid in the other direction. For example, depending on the function executed in the electronic device 1, the controller 11 may detect the gesture made by the user as valid only in the up-down direction, i.e. upward or downward. Depending on the function executed in the electronic device 1, the controller 11 may detect the gesture made by the user as valid only in the right-left direction, i.e. rightward or leftward. Thus, the controller 11 may determine a gesture in a direction other than the priority direction, as an invalid gesture. Since the controller 11 can determine the direction of the gesture while regarding a gesture in a direction that cannot be carried out in the electronic device 1 as invalid, the gesture made by the user is more likely to be detected as an operation intended by the user.

The state of the electronic device 1 may be determined on the basis of both of the orientation of the screen displayed on the display 14 and the function executed in the electronic device 1. The state of the electronic device 1 may include any other state different from the above-mentioned examples.

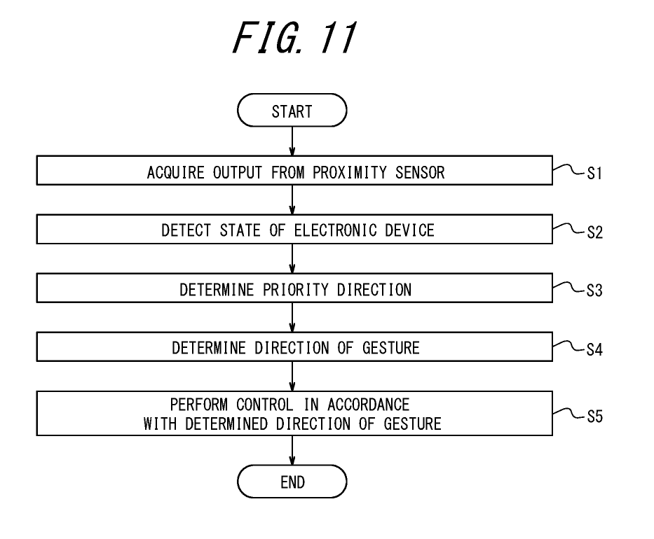

FIG. 11 is a flowchart illustrating an example of the process performed by the electronic device 1.

First, the controller 11 of the electronic device 1 acquires the output from the proximity sensor 18 (step S1).

The controller 11 detects the state of the electronic device 1 (step S2). The state of the electronic device 1 may be the orientation of the screen displayed on the display 14, or may be determined on the basis of the function executed in the electronic device 1, as mentioned above.

The controller 11 determines the priority direction, in accordance with the output from the proximity sensor 18 acquired in step S1 and the state of the electronic device 1 detected in step S2 (step S3).

The controller 11 determines the direction of the gesture made by the user, on the basis of the determined priority direction (step S4).

The controller 11 performs control in accordance with the direction of the gesture determined in step S4 (step S5).

As described above, the electronic device 1 according to this embodiment determines the direction of the gesture in accordance with the output from the proximity sensor 18 and the state of the electronic device 1. Hence, the electronic device 1 can easily detect the gesture made by the user as the operation intended by the user, in accordance with the state of the electronic device 1. The electronic device 1 can thus effectively prevent an operation error in gesture input operation.

(Gesture Validity Determination Process)

The gesture validity determination process performed by the controller 11 of the electronic device 1 is described below. The gesture validity determination process performed by the controller 11 may be performed, for example, in the case where the electronic device 1 is in the kitchen mode.

The user may want to continuously operate the screen displayed on the display 14 in one direction (e.g. up-down direction) in relation to the electronic device 1. For example, the user may want to perform continuous scrolling using a continuous gesture in one direction. In such a case, the user can make, for example, a continuous gesture in one direction. The term “continuous gesture in one direction” encompasses repeatedly making a gesture in one direction without stopping the movement of the hand with which the gesture is being made. The term “continuous scrolling” encompasses performing screen transition by scrolling the screen without stopping.

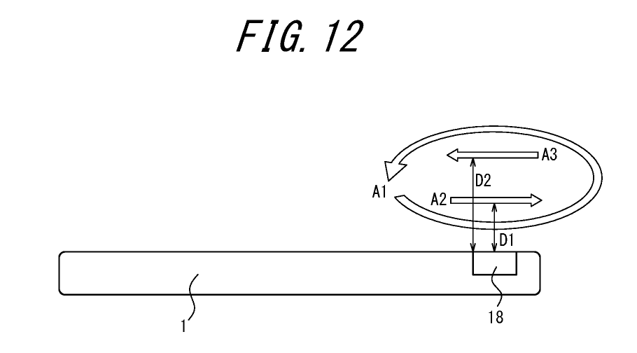

FIG. 12 is a diagram illustrating an example of a continuous gesture made by the user. FIG. 12 is a side view of the electronic device 1, where the movement of a gesture made by the user with his or her hand is schematically indicated by an arrow A1. In FIG. 12, the position of the proximity sensor 18 in the electronic device 1 is indicated for the purpose of illustration. As illustrated in FIG. 12, in the case of making a continuous gesture, the user repeatedly moves the hand in a circular (i.e. elliptic) pattern (or in reciprocating motion) on the front side of the proximity sensor 18 in a side view of the electronic device 1. Here, there is a possibility that the gesture made by the user is detected not as an operation of moving along a circular arc as indicated by the arrow A1, but as a continuous gesture in opposite directions (right-left direction in FIG. 12) as schematically indicated by arrows A2 and A3. If the gesture made by the user is detected as a continuous gesture in opposite directions, the controller 11 of the electronic device 1 will end up repeatedly transitioning the screen displayed on the display 14 in opposite directions (i.e. up and down). In other words, for example, the screen displayed on the display 14 is repeatedly scrolled upward and downward alternately. Since the user intends the operation to be continuous scrolling in one direction, an operation error occurs if a process of repeatedly transitioning the screen in opposite directions is performed by the electronic device 1.

The controller 11 of the electronic device 1 according to this embodiment determines, in the case where a plurality of gestures are continuously made, whether a gesture (hereafter also referred to as “second gesture”) following a gesture (hereafter also referred to as “first gesture”) made first is valid or invalid. The first gesture may be, for example, associated with the gesture indicated by the arrow A2 in FIG. 12. The second gesture may be, for example, associated with the gesture indicated by the arrow A3 in FIG. 12.

The controller 11 determines whether the second gesture is valid or invalid, based on the first gesture and the second gesture. In detail, the controller 11 determines whether or not the second gesture satisfies a predetermined condition with regard to the first gesture and, based on the result of the determination, determines whether the second gesture is valid or invalid. In the case of determining that the second gesture is valid, the controller 11 performs a process based on the second gesture after performing a process based on the first gesture. In the case of determining that the second gesture is invalid, the controller 11 performs the process based on the first gesture, but does not perform the process based on the second gesture. In this way, the electronic device 1 determines whether or not the second gesture is intended by the user and, in the case of determining that the second gesture is not intended by the user, does not perform the process based on the second gesture. The electronic device 1 can thus effectively prevent an operation error in gesture input operation.

The second gesture validity determination condition and the validity determination process based on the determination condition performed by the controller 11 are described in detail below, using several examples.

A first determination condition is a time-related condition. In the case where the time from the first gesture to the second gesture is greater than or equal to a predetermined time, the controller 11 may determine that the second gesture is valid. In the case where the time from the first gesture to the second gesture is less than the predetermined time, the controller 11 may determine that the second gesture is invalid.

For example, the time from the first gesture to the second gesture may be the time from when the detection of the first gesture by the proximity sensor 18 starts to when the detection of the second gesture by the proximity sensor 18 starts. Alternatively, the time from the first gesture to the second gesture may be the time from when the detection of the first gesture by the proximity sensor 18 ends to when the detection of the second gesture by the proximity sensor 18 starts.

The predetermined time may be such a time that allows the gesture made by the user to be recognized as a continuous gesture. For example, in the case where the time from the first gesture to the second gesture is the time from when the detection of the first gesture by the proximity sensor 18 ends to when the detection of the second gesture by the proximity sensor 18 starts, the predetermined time may be 0.3 sec. The predetermined time may be set as appropriate in accordance with, for example, a function or application executed in the electronic device 1.

For example, in the case of making a continuously gesture in one direction with the intention for continuous scrolling, the user is expected to quickly move the hand back to the position where the first gesture was started, in order to continuously make the first gesture which is a gesture in the intended direction. In view of this, in the case where the user makes a continuously gesture in one direction with the intention for continuous scrolling, the time from the first gesture which is a gesture in the intended direction to the second gesture which is a gesture not in the intended direction is expected to be less than the predetermined time. Accordingly, in the case where the time from the first gesture to the second gesture is less than the predetermined time, the controller 11 can determine the second gesture as an unintended gesture, and set the second gesture as invalid. The controller 11 does not perform the process based on the second gesture determined as an unintended gesture. The electronic device 1 can thus effectively prevent an operation error in gesture input operation.

A second condition is a direction-related condition. In the case where it is determined that the direction of the first gesture and the direction of the second gesture have a predetermined relationship, the controller 11 may determine the second gesture as invalid. In the case where it is determined that the direction of the first gesture and the direction of the second gesture does not have the predetermined relationship, the controller 11 may determine the second gesture as valid.

For example, the predetermined relationship may be a relationship of being in opposite directions. In detail, in the case where it is determined that the direction of the first gesture and the direction of the second gesture are opposite directions, the controller 11 may determine the second gesture as invalid. In the case where it is determined that the direction of the first gesture and the direction of the second gesture are not opposite directions (e.g. the same direction or orthogonal directions), the controller 11 may determine the second gesture as valid.

For example, in the case where a continuous gesture is made in one direction with the intention for continuous scrolling, the user is expected to, after making the first gesture, move the hand back to the position at which the first gesture was started, in order to continuously make the first gesture in the intended direction. In view of this, the second gesture is expected to be in an opposite direction to the first gesture. Accordingly, in the case where the direction of the first gesture and the direction of the second gesture have the predetermined relationship (i.e. the relationship of being opposite directions), the controller 11 can determine the second gesture as an unintended gesture, and set the second gesture as invalid. The controller 11 does not perform the process based on the second gesture determined as an unintended gesture. The electronic device 1 can thus effectively prevent an operation error in gesture input operation.

A third condition is a distance-related condition. In the case where the distance (first distance) from the position of the first gesture to the proximity sensor 18 is greater than or equal to the distance (second distance) from the position of the second gesture to the proximity sensor 18, the controller 11 may determine the second gesture as valid. In the case where the distance (first distance) from the position of the first gesture to the proximity sensor 18 is less than the distance (second distance) from the position of the second gesture to the proximity sensor 18, the controller 11 may determine the second gesture as invalid.

In FIG. 12, the first distance is indicated by D1 as an example. For example, the first distance may be the distance between the first gesture and the proximity sensor 18 when the first gesture is closest to the proximity sensor 18. Alternatively, the first distance may be the average distance between the first gesture and the proximity sensor 18.

In FIG. 12, the second distance is indicated by D2 as an example. For example, the second distance may be the distance between the second gesture and the proximity sensor 18 when the second gesture is closest to the proximity sensor 18. Alternatively, the second distance may be the average distance between the second gesture and the proximity sensor 18.

The first distance and the second distance are not limited to the above-mentioned examples, and may be defined in any way as long as their definitions are the same (i.e. as long as they are defined on the basis of the same standard).

For example, in the case where a continuous gesture is made in one direction with the intention for continuous scrolling, the user is expected to make the first gesture, which is a gesture in the intended direction, near the proximity sensor 18, in order to facilitate the detection of the first gesture by the proximity sensor 18. In the case of making a continuous gesture in one direction, the user is expected to make the second gesture, which is a gesture not in the intended direction, farther from the proximity sensor 18 than the first gesture. Thus, the second gesture is expected to be farther from the proximity sensor 18 than the first gesture. Accordingly, in the case where the first distance is less than the second distance, the controller 11 can determine the second gesture as an unintended gesture, and set the second gesture as invalid. The controller 11 does not perform the process based on the second gesture determined as an unintended gesture. The electronic device 1 can thus effectively prevent an operation error in gesture input operation.

A fourth condition is a speed-related condition. In the case where the speed (first speed) of the first gesture is lower than the speed (second speed) of the second gesture, the controller 11 may determine the second gesture as valid. In the case where the speed (first speed) of the first gesture is higher than the speed (second speed) of the second gesture, the controller 11 may determine the second gesture as invalid.

The first speed is the speed of the gesture detected as the arrow A2 in FIG. 12. The second speed is the speed of the gesture detected as the arrow A3 in FIG. 12. The controller 11 calculates, based on each gesture detected by the proximity sensor 18, the speed of the gesture, and compares the first speed and the second speed.

For example, in the case where a continuous gesture is made in one direction with the intention for continuous scrolling, the user makes the first gesture, which is a gesture in the intended direction, at a predetermined speed, and then moves the hand back to the position where the first gesture was started. Here, since the second gesture which is an operation of moving the hand back to the position where the first gesture was started is not a gesture intended by the user, the second gesture is expected to be slower than the first gesture. Thus, the second gesture is expected to be slower than the first gesture. Accordingly, in the case where the first speed is higher than the second distance, the controller 11 can determine the second gesture as an unintended gesture, and set the second gesture as invalid. The controller 11 does not perform the process based on the second gesture determined as an unintended gesture. The electronic device 1 can thus effectively prevent an operation error in gesture input operation.

The controller 11 may combine any two or more conditions out of the first to fourth conditions, in determining whether the second gesture is valid or invalid. In detail, the controller 11 may determine whether the second gesture is valid or invalid, based on any two or more conditions from among the conditions relating to: the time from the first gesture to the second gesture; the directions of the first gesture and the second gesture; the distance between the position of the first gesture and the proximity sensor 18 and the distance between the position of the second gesture and the proximity sensor 18; and the speeds of the first gesture and the second gesture.

Here, the controller 11 may determine whether the second gesture is valid or invalid, with a weight being assigned to each condition for determining whether the gesture is valid or invalid. For example, in the case where the user continuously makes a gesture in one direction, the user needs to, after the first gesture, move the hand back to the position where the first gesture was started, so that the second gesture tends to be in an opposite direction to the first gesture. In other words, the condition relating to the direction of the gesture, i.e. the second condition, tends to be satisfied. On the other hand, the relationship for the distance between the gesture and the proximity sensor 18, i.e. the third condition, may not necessarily be satisfied depending on the user. For example, depending on the user, even in the case of continuously making a gesture in one direction, there are instances where the first distance is greater than or equal to the second distance. Thus, the condition relating to the distance relationship, i.e. the third condition, is less likely to be satisfied than the condition relating to the direction of the gesture, i.e. the second condition. In view of this, the controller 11 may, for example, perform such weighting that grades the second condition higher than the third condition. The controller 11 may thus perform weighting as appropriate, depending on which conditions are used to determine whether the second gesture is valid or invalid. By such weighting, the controller 11 can more accurately determine whether or not the second gesture is intended by the user.

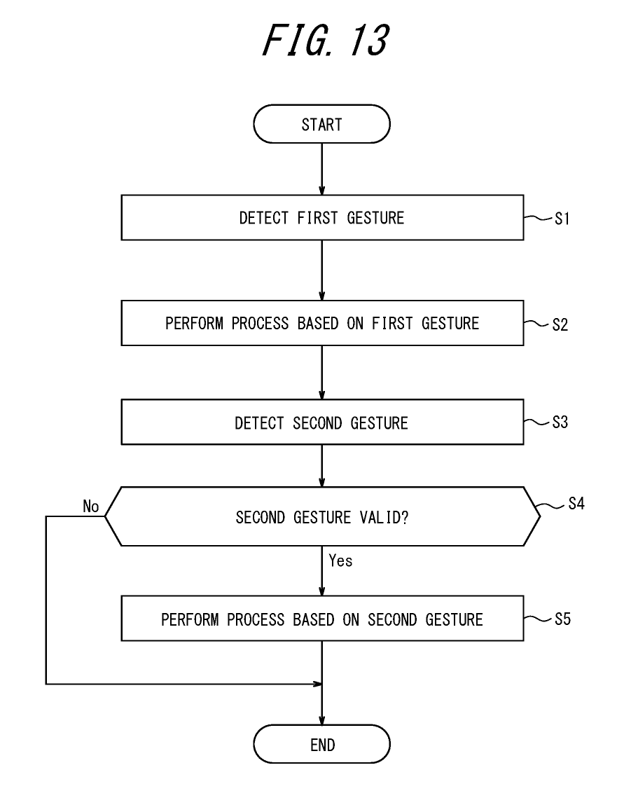

FIG. 13 is a flowchart illustrating an example of the process performed by the electronic device 1.

First, the controller 11 of the electronic device 1 detects the first gesture based on the output of the proximity sensor 18 (step S1).

The controller 11 performs the process based on the first gesture detected in step S1 (step S2).

The controller 11 detects the second gesture based on the output of the proximity sensor 18 (step S3).

The controller 11 determines whether or not the second gesture is valid (step S4). In detail, the controller 11 may determine whether or not the second gesture is valid, using any of the above-mentioned conditions.

In the case where it is determined that the second gesture is valid (step S4: Yes), the controller 11 performs the process based on the second gesture (step S5). The controller 11 then ends the process in the flowchart.

In the case where it is determined that the second gesture is invalid (step S4: No), the controller 11 determines that the second gesture is not intended by the user, and ends the process in the flowchart without performing the process based on the second gesture.

As described above, the electronic device 1 according to this embodiment determines whether the second gesture is valid or invalid, based on the first gesture and the second gesture. In this way, the electronic device 1 determines whether or not the second gesture was intended by the user. In the case of determining that the second gesture was not intended by the user, the electronic device 1 does not perform the process based on the second gesture. The electronic device 1 can thus effectively prevent an operation error in gesture input operation.

(Further Embodiments)

Although the disclosed device, method, and medium have been described by way of the drawings and embodiments, various changes and modifications may be easily made by those of ordinary skill in the art based on this disclosure. Such various changes and modifications are therefore included in the scope of this disclosure. For example, the functions included in the means, steps, etc. may be rearranged without logical inconsistency, and a plurality of means, steps, etc. may be combined into one means, step, etc. and a means, step, etc. may be divided into a plurality of means, steps, etc.

Although the above embodiments describe the case where a gesture is detected by the proximity sensor 18, the gesture need not necessarily be detected by the proximity sensor 18. The gesture may be detected by any contactless sensor capable of contactlessly detecting a gesture made by the user. Examples of the contactless sensor include the camera 13 and the illumination sensor 20.

Each of the conditions described in the above embodiments for determining whether the second gesture is valid or invalid may be set appropriately in accordance with the gesture to be determined as invalid. For example, although the above embodiments describe the case where the controller 11 determines the second gesture as invalid if, as the second condition, the direction of the first gesture and the direction of the second gesture are opposite directions, the second condition may be set so that the controller 11 determines the second gesture as invalid if the direction of the first gesture and the direction of the second gesture are the same direction.

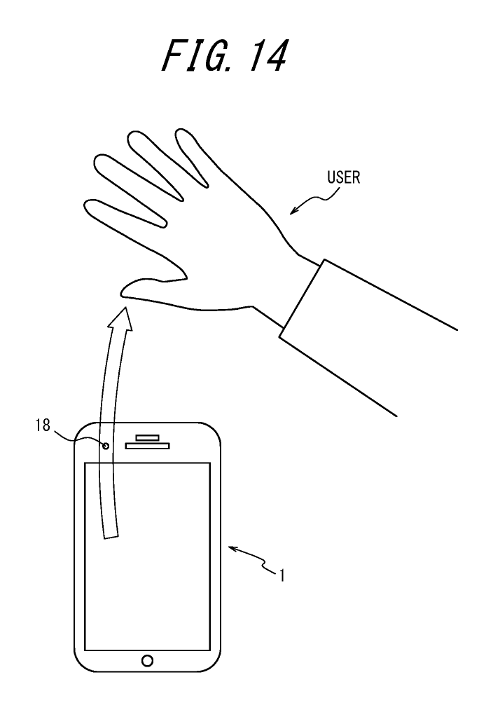

For example, suppose the user makes a gesture with the fingers and thumb spread apart, as illustrated in FIG. 14. There is a possibility that, based on the output of the proximity sensor 18, the controller 11 detects the gestures of the user's little finger, ring finger, middle finger, index finger, and thumb as different gestures, and thus detects five gestures corresponding to the respective fingers and thumb. In the case where the user actually intends to make one gesture by moving the hand upward, an operation error occurs if the controller 11 detects the gesture made by the user as five gestures.

However, by setting the second condition so that the controller 11 determines the second gesture as invalid if the direction of the first gesture and the direction of the second gesture are the same direction, the gestures of the five fingers in the same direction are prevented from being determined as different gestures. The electronic device 1 can thus effectively prevent an operation error.

Many of the disclosed aspects are described in terms of sequences of operations performed by a computer system or other hardware capable of executing program instructions. Examples of the computer system or other hardware include a general-purpose computer, personal computer (PC), dedicated computer, workstation, personal communications system (PCS), cellular phone, cellular phone capable of data processing, RFID receiver, game machine, electronic notepad, laptop computer, global positioning system (GPS) receiver, and other programmable data processors. Note that, in each embodiment, various operations or control methods are executed by dedicated circuitry (e.g. discrete logical gates interconnected to realize specific functions) implemented by program instructions (software) or logical blocks, program modules, etc. executed by at least one processor. Examples of at least one processor executing logical blocks, program modules, etc. include at least one microprocessor, central processing unit (CPU), application specific integrated circuit (ASIC), digital signal processor (DSP), programmable logic device (PLD), field programmable gate array (FPGA), processor, controller, microcontroller, microprocessor, electronic device, other devices designed to execute the functions described herein, and/or any combination thereof. The embodiments described herein are implemented, for example, by hardware, software, firmware, middleware, microcode, or any combination thereof. Instructions may be program code or code segments for performing necessary tasks, and may be stored in a non-transitory machine-readable storage medium or other medium. A code segment may represent a procedure, a function, a subprogram, a program, a routine, a subroutine, a module, a software package, a class, or any combination of instructions, data structures, or program statements. A code segment is connected to another code segment or a hardware circuit, by performing transmission and/or reception of information, data arguments, variables, or storage contents with the other code segment or hardware circuit.

The storage 16 used herein may be in any tangible form of computer-readable carrier (medium) in the categories of solid-state memory, magnetic disk, and optical disk. Such a medium stores an appropriate set of computer instructions, such as program modules, or data structures for causing a processor to carry out the techniques disclosed herein. Examples of the computer-readable medium include an electrical connection having one or more wires, magnetic disk storage medium, magnetic cassette, magnetic tape, other magnetic and optical storage devices (e.g. compact disk (CD), LaserDisc® (LaserDisc is a registered trademark in Japan, other countries, or both), digital versatile disc (DVD® (DVD is a registered trademark in Japan, other countries, or both)), Floppy® (floppy is a registered trademark in Japan, other countries, or both)) disk, Blu-ray Disc®), portable computer disk, random access memory (RAM), read-only memory (ROM), erasable programmable read-only memory (EPROM), electrically erasable programmable read-only memory (EEPROM), flash memory, other rewritable and programmable ROM, other tangible storage medium capable of storage, and any combination thereof. Memory may be provided inside and/or outside a processor or a processing unit. The term “memory” used herein indicates any type of memory such as long-term storage, short-term storage, volatile, nonvolatile, or other memory. The number and/or types of memory are not limited, and the types of storage media are not limited.

1. An electronic device comprising:
a proximity sensor; and
a controller configured to determine a direction of a gesture in accordance with an output from the proximity sensor and a state of the electronic device.

2. The electronic device according to claim 1,
wherein the controller is configured to determine, in accordance with the output from the proximity sensor and the state of the electronic device, a priority direction preferentially determined as the direction of the gesture, and determine the direction of the gesture on the basis of the priority direction.

3. The electronic device according to claim 2,
wherein the controller is configured to determine a gesture in a direction other than the priority direction as an invalid gesture.

4. The electronic device according to claim 2, further comprising
a display configured to display a screen,
wherein the priority direction is any of an up-down direction and a right-left direction of the screen displayed on the display.

5. The electronic device according to claim 1, further comprising
a display configured to display a screen,
wherein the state of the electronic device is an orientation of the screen displayed on the display.

6. The electronic device according to claim 1,
wherein the state of the electronic device is determined in accordance with a function executed at a time of the output from the proximity sensor.

7. The electronic device according to claim 1,
wherein the controller is configured to perform control in accordance with the determined direction of the gesture.

8. A computer-readable non-transitory recording medium storing therein instructions to be executed by an electronic device including a proximity sensor and a controller, the instructions causing the controller to
determine a direction of a gesture in accordance with an output from the proximity sensor and a state of the electronic device.

9. A control method for an electronic device including a proximity sensor and a controller, the control method comprising
determining, by the controller, a direction of a gesture in accordance with an output from the proximity sensor and a state of the electronic device.

10. An electronic device comprising:
a proximity sensor; and
a controller configured to perform a process on the basis of a gesture in accordance with an output from the proximity sensor,
wherein the controller is configured to determine, when a second gesture is detected after a first gesture in accordance with the output from the proximity sensor, whether the second gesture is valid or invalid, on the basis of the first gesture and the second gesture.

11. The electronic device according to claim 10,
wherein the controller is configured to:
determine that the second gesture is valid in a case where a time from the first gesture to the second gesture is greater than or equal to a predetermined time; and
determine that the second gesture is invalid, in a case where the time from the first gesture to the second gesture is less than the predetermined time.

12. The electronic device according to claim 10,
wherein the controller is configured to determine that the second gesture is invalid, in a case where it is determined that a direction of the first gesture and a direction of the second gesture are opposite directions.

13. The electronic device according to claim 10,
wherein the controller is configured to:
determine that the second gesture is valid in a case where a distance between a position of the first gesture and the proximity sensor is greater than or equal to a distance between a position of the second gesture and the proximity sensor; and
determine that the second gesture is invalid in a case where the distance between the position of the first gesture and the proximity sensor is less than the distance between the position of the second gesture and the proximity sensor.

14. The electronic device according to claim 10,
wherein the controller is configured to:
determine that the second gesture is valid in a case where a speed of the first gesture is lower than a speed of the second gesture; and
determine that the second gesture is invalid in a case where the speed of the first gesture is higher than the speed of the second gesture.

15. The electronic device according to claim 10,
wherein the controller is configured to determine whether the second gesture is valid or invalid, on the basis of two or more conditions from: a time from the first gesture to the second gesture; directions of the first gesture and the second gesture; a distance between a position of the first gesture and the proximity sensor and a distance between a position of the second gesture and the proximity sensor; and speeds of the first gesture and the second gesture.

16. A computer-readable non-transitory recording medium storing therein instructions to be executed by an electronic device including a proximity sensor and a controller, the instructions causing the controller to:
perform a process on the basis of a gesture in accordance with an output from the proximity sensor; and
determine, when a second gesture is detected after a first gesture in accordance with the output from the proximity sensor, whether the second gesture is valid or invalid, on the basis of the first gesture and the second gesture.

17. A control method for an electronic device including a proximity sensor and a controller, the control method comprising:
performing, by the controller, a process on the basis of a gesture in accordance with an output from the proximity sensor; and
determining, by the controller, when a second gesture is detected after a first gesture in accordance with the output from the proximity sensor, whether the second gesture is valid or invalid, on the basis of the first gesture and the second gesture.
